(19) United States
(12) Patent Application Publication
(10) Pub. No.: US 2006/0104355 A1
(43) Pub. Date: May 18, 2006

(54) METHOD FOR SETTING THE THRESHOLD OF A FAST MOTION ESTIMATION ALGORITHM

(76) Inventors: Chih-Feng Chang, Hsinchu City (TW); Chun-Liang Tu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/905,401

(22) Filed: Dec. 31, 2004

(30) Foreign Application Priority Data
Nov. 16, 2004 (TW) 93135037

(51) Int. Cl. H04N 7/12; H04N 11/04; H04B 1/66; H04N 11/02

(52) U.S. Cl. 375/240.12; 375/240.24

(57) ABSTRACT

A method for setting the threshold of a fast motion estimation algorithm, which improves the accuracy precision of motion vectors at the edges of objects and the algorithm efficiency in the background area when used together with threshold-based fast motion estimation algorithms. The steps of the method includes determining whether a macroblock is located at the edge of a moving object; setting the threshold of the fast motion estimation algorithm to a smaller edge threshold when the macroblock is at an edge; and setting the threshold of the fast motion estimation algorithm to a larger background threshold when the macroblock is not at an edge.

### CROSS-REFERENCE TO RELATED APPLICATION

This application claims the priority benefit of Taiwan application serial no. 93135037, filed Nov. 16, 2004.

### BACKGROUND OF THE INVENTION

1. Field of Invention

The present invention relates to the fast motion estimation algorithms used in video coding, and in particular to the method for setting the thresholds of a fast motion estimation algorithm.

2. Description of Related Art

Generally, the error functions are used to determine the similarity of macroblocks in the motion estimation algorithms used in video coding, while thresholds are used to interrupt the heavy and complicated calculation for motion estimation in threshold-based fast motion estimation algorithms. Usually, for the macroblocks located in the edge of a moving object, the motion vector predicted by the left and top adjacent macroblock are very inaccurate, so a small threshold is required to perform a relatively complete searching so as to find out the optimum motion vector. However, in the background area other than the edges, if the threshold is too small, it then results in the unnecessary operation which reduces the efficiency of the algorithm.

The prior art techniques do not change the threshold according to whether the macroblock is in the edge of a moving object. Accordingly, a better method is desirable in order to solve aforesaid dilemmatic problem.

### SUMMARY OF THE INVENTION

The object of the present invention is to provide a method for setting the threshold of the fast motion estimation algorithm in order to solve the dilemmatic problem confronted in the conventional techniques. The invention can efficiently reduce the bit rate under an almost same encoding frame rate and image quality.

In order to achieve aforesaid and other objects, the present invention provides a method for setting the threshold of the fast motion estimation algorithm comprising following steps. First at all, it is determined whether or not the macroblock is located in the edge of a moving object image. A threshold for the fast motion estimation algorithm is set, according to the determining result.

In the foregoing method for setting the threshold of the fast motion estimation algorithm, as an embodiment, if the macroblock is determined in the edge of an object, then an edge threshold is set as the threshold of the fast motion estimation algorithm. Otherwise, a background threshold is set as the threshold of the fast motion estimation algorithm.

In the foregoing method for setting the threshold of the fast motion estimation algorithm, as an embodiment, the edge threshold is less than the background threshold.

In the foregoing method for setting the threshold of the fast motion estimation algorithm, as an embodiment, the criterion for determining whether or not a macroblock is located in the edge of a moving object includes a left optimum error of the left marcoblock adjacent to aforesaid marcoblock, and a top optimum error of the top marcoblock adjacent to aforesaid marcoblock.

In the foregoing method for setting the threshold of the fast motion estimation algorithm, as an embodiment, if |Et−El|>a×Min (Et, El), then the marcoblock is determined as locating in the edge of a moving object; otherwise it is determined not on the edge of an object. Wherein, Et denotes the top optimum error, El denotes the left optimum error, | | denotes the absolute value evaluating operation, a denotes a preset numerical value that is greater than 0, and Min denotes minimum value evaluating operation.

In the foregoing method for setting the threshold of the fast motion estimation algorithm, as an embodiment, the criterion determining whether a macroblock is located in the edge of a moving object further includes a prediction error of the marcoblock itself.

In the foregoing method for setting the threshold of the fast motion estimation algorithm, as an embodiment, if Max (|Et−El|, |Et−Ep|, |El−Ep|)>b×Min (Et, El, Ep), then the marcoblock is determined as locating in the edge of a moving object; otherwise it is determined not in the edge of the moving object image. Wherein, Ep denotes the prediction error of the marcoblock, Max denotes the maximum value evaluating operation, b denotes a preset numerical value that is greater than 0

As has been described in the preferred embodiment of the present invention, because the present invention uses the relatively small threshold in the edge of an object and the relatively large threshold in the background area, therefore both the precision of the motion vectors of the macroblocks located on the edge of the moving object image and the efficiency of the algorithm in the background area are taken into account. Accordingly, the present invention has successfully solved the dilemmatic problem that the prior art technique faces. The present invention can effectively reduce the bit rate under the almost same encoding frame rate and image quality.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic drawing for the relative positions of macroblocks.

FIG. 2 is a drawing, schematically illustrating an application result, according to an embodiment of the present invention

FIG. 3 is a drawing, schematically illustrating a flow-process diagram, according to an embodiment of the present invention

### DESCRIPTION OF THE PREFERRED EMBODIMENTS

The following preferred embodiment of the present invention is used to illustrate the method for setting threshold of fast motion estimation algorithms.

Generally speaking, the larger a prediction optimum error of a marcoblock is, the more complicated it is, and it is probably located in a moving object. Also and, the smaller a predicted optimum error of a marcoblock is, the simpler it is, and it is probably located in a background area. The area between a complicated marcoblock and a simple one is probably the edge of a moving object image.

Based on aforesaid conceptions, the preferred embodiment uses a simple operational formula to determine whether or not a macoblock is located in the edge of a moving object. If it is so, an edge threshold having a small numerical value is set as the threshold of the fast motion estimation algorithm, in order to search the optimum motion vector. Otherwise, a background threshold having a large numerical value is set as the threshold of the fast motion estimation algorithm, in order to interrupt the heavy and complicated motion estimation operation as soon as possible in order to raise the operational efficiency.

As to the details of edge determination, please refer to FIG. 1. There are 3 adjacent marcoblocks in FIG. 1. Let 101 be the macroblock to be determined. The first determining method of the preferred embodiment is checking whether or not |Et−El| is greater than a×Min ( Et, El ). If it is greater, then macroblock 101 is determined as locating in the edge of a moving object image. Otherwise, it is not. Wherein, Et denotes the optimum error predicted by the top macroblock 103 adjacent to marcoblock 101 (hereinafter referring as the top optimum error), El denotes the optimum error predicted by the left marcoblock 102 adjacent to marcoblock 101 (hereafter referred as the left optimum error), | | denotes taking absolute value operation, Min denotes taking minimum value operation and a denotes a preset numerical value that is greater than 0 and can be preset according to the need.

The second determining method of the preferred embodiment is checking whether or not the Max (|Et−El|, |Et−Ep|, |El−Ep|) is greater than b×Min (Et, El, Ep). If it is greater, then marcoblock 101 is determined to be locating in the edge of a moving object image. Otherwise, it is not. Wherein, Ep denotes the error predicted by marcoblock 101 itself, that is the error calculated using the predicted motion vector, Max denotes the maximum value evaluating operation, b denotes a preset numerical value that is greater than 0, and is preset according to the need, the definition of other symbols as above. As to the choice between aforesaid two determining criteria, it can be determined according to the actual design by a person ordinary skilled in the art.

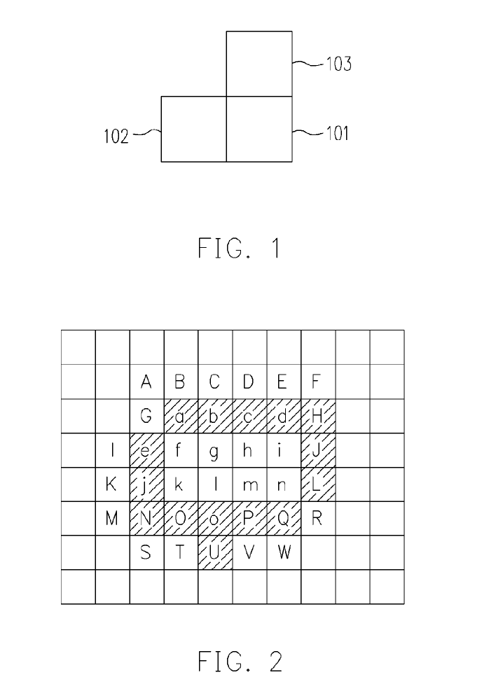

An application result of the preferred embodiment is shown as FIG. 2. There is an irregular object in FIG. 2, wherein the macroblocks from a to o are occupied by the object, the macroblocks from A to W are used, corresponding to the background. The macroblocks in the edge of the object can be determined efficiently by the preferred embodiment. They are marked in FIG. 2 by oblique lines, which include macroblocks a, b, c, d, H, e, J, j, L, N, O, o, P, Q, U.

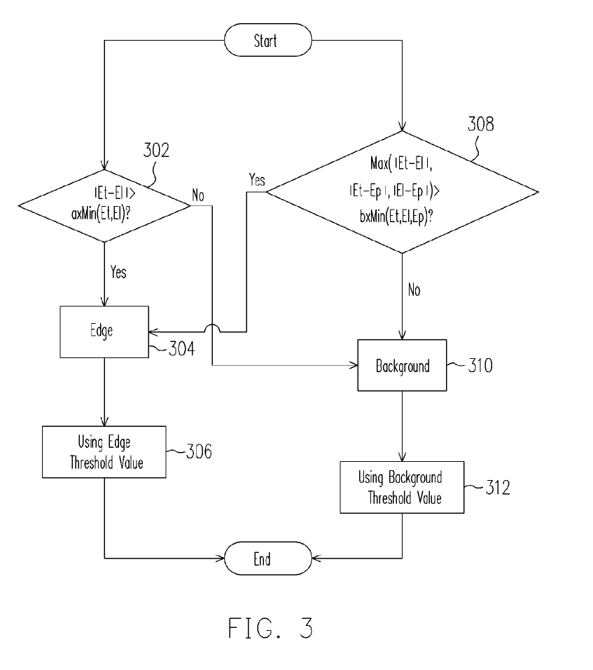

The flow-process diagram of the preferred embodiment is shown in FIG. 3. First at all, it is determined which one of the edge determining methods is used. If the aforesaid first method is chosen, the step 302 is carried out; if the aforesaid second method is chosen, the step 308 is carried out. No matter which method is used, if the operational formula is true, the process then goes to the step 304, and the macroblock is determined as locating in the edge of aforesaid object. Then, in step 306, an edge threshold having a small numerical value is used as the threshold of the fast motion estimation algorithm. On the contrary, if the operational formula in step 302 or 308 is false, the process then goes to the step 310, and the macroblock is determined as locating in the background area other than the edge of aforesaid object. Then, in step 312, a background threshold having a large numerical value is used as the threshold of the fast motion estimation algorithm.

As described above, because the present invention uses the relatively small threshold in the edge of an object and the relatively large threshold in the background area, both the precision of the motion vector of the macroblocks located in the edge of the object image and the efficiency of the algorithm in the background area are taken into account. Accordingly, the present invention can effectively solve the dilemmatic problem in conventional techniques. The present invention can effectively reduce the bit rate under the almost the same encoding frame rate and image quality.

Although the preferred embodiment is used to illustrate the present invention clearly, it is not a restriction on the present invention. Any person who is familiar with the technical field related to the present invention can modify it slightly without deviation from the spirit and range of the present invention. Therefore following claim file is the only criterion of the protection range of the present invention.

What is claimed is:

1. A method for setting a threshold of a fast motion estimation algorithm, comprising:
determining whether or not a macroblock is located in an edge of a moving object; and
setting a threshold for the fast motion estimation algorithm, according to a result from the previous step.

2. The method as recited in claim 1, wherein the step of setting the threshold of the fast motion estimation algorithm comprises: using an edge threshold as the threshold of the fast motion estimation algorithm if the macroblock is in the edge of the moving object; otherwise using a background threshold as the threshold of the fast motion estimation algorithm.

3. The method as recited in claim 2, wherein the edge threshold is less than the background threshold.

4. The method as recited in claim 1, wherein a criterion used in the step of determining whether or not the macroblock is located in the edge of the moving object comprises a left optimum error of a left macroblock adjacent to the macroblock and a top optimum error of an upper macroblock adjacent to the macroblock.

5. The method as recited in claim 4, wherein the step of determining whether or not the macroblock is located in the edge of the object comprises:
if |Et−El|>a×Min (Et, El), then the macroblock is located in the edge of the moving object, otherwise the macroblock is not located on the edge of the moving object image, wherein Et denotes the upper optimum error, El denotes the left optimum error, | | denotes taking absolute value operation, a denotes a numerical value that is greater than 0, and Min denotes taking minimum value operation .

6. The method as recited in claim 4, wherein a criterion used in the step of determining whether or not the macroblock is located in the edge of the object further comprises a prediction error of the macroblock.

7. The method as recited in claim 6, wherein the step of determining whether or not the macroblock is located in the edge of the moving object image comprises:
if Max (|Et−El|, |Et−Ep|, |El−Ep|)>b×Min (Et, El, Ep), then the macroblock is in the edge of the moving object, otherwise the macroblock is not in the edge of aforesaid object image, wherein Et denotes the upper optimum error, El denotes the left optimum error, Ep denotes the prediction error of the macroblock, | | denotes taking absolute value evaluating operation, Max denotes taking maximum value evaluating operation, b denotes a preset numerical value that is greater than 0, and Min denotes taking minimum value evaluating operation.
